(19) United States
(12) Patent Application Publication
(10) Pub. No.: US 2026/0084704 A1
(43) Pub. Date: Mar. 26, 2026

(54) CONTROL SYSTEM, CONTROL METHOD, AND RECORDING MEDIUM

(71) Applicant: INTER-UNIVERSITY RESEARCH INSTITUTE CORPORATION RESEARCH ORGANIZATION OF INFORMATION AND SYSTEMS, Tokyo (JP)

(72) Inventors: Clovis EBERHART, Tokyo (JP); Jeremy DUBUT, Tokyo (JP); James HAYDON, Tokyo (JP); Ichiro HASUO, Tokyo (JP)

(21) Appl. No.: 19/400,337

(22) Filed: Nov. 25, 2025

Related U.S. Application Data
(63) Continuation of application No. PCT/JP2024/018673, filed on May 21, 2024.

(30) Foreign Application Priority Data
May 31, 2023 (JP) 2023-090138

(51) Int. Cl. B60W 50/00; B60W 60/00

(52) U.S. Cl. CPC B60W 50/0097; B60W 60/001; B60W 2555/20

(57) ABSTRACT

A control system includes a processor; and a memory storing program instructions that cause the processor to control an operation of an object and output state information indicating a state of the controlled object; perform first control that operates the controlled object according to a first safety rule; perform second control that operates the controlled object according to a second safety rule; and perform the first control in response to determining that the state information satisfies a first switching condition defined based on the first safety rule and the second safety rule, and perform the second control in response to determining that the state information does not satisfy the first switching condition.

### CROSS-REFERENCE TO RELATED APPLICATIONS

This application is a continuation application of International Application No. PCT/JP2024/018673 filed on May 21, 2024, and designating the U.S., which is based upon and claims priority to Japanese Application No. 2023-090138 filed on May 31, 2023, the entire contents of which are incorporated herein by reference.

### BACKGROUND

### 1. Technical Field

The present disclosure relates to a control system, a control method, and a recording medium.

### 2. Description of the Related Art

As a control system for guaranteeing safety, the simplex architecture has been proposed (Non-patent documents 1 and 2). As safety rules in autonomous driving, Responsibility-Sensitive Safety (RSS) (Non-Patent Document 3) and Goal Aware RSS (GA-RSS) have been proposed (Non-Patent Document 4).

### RELATED ART DOCUMENT

### Non-Patent Document

Non-Patent Document 1: T. L. Crenshaw, E. Gunter, C. L. Robinson, L. Sha, and P. R. Kumar, “The simplex reference model: Limiting fault-propagation due to unreliable components in cyber-physical system architectures,” in 28th IEEE International Real-Time Systems Symposium (RTSS 2007), 2007, pp. 400-412
Non-Patent Document 2: D. Seto, B. Krogh, L. Sha, and A. Chutinan, “The simplex architecture for safe online control system upgrades,” in Proceedings of the 1998 American Control Conference. ACC (IEEE Cat. No. 98CH36207), vol. 6, 1998, pp. 3504-3508
Non-Patent Document 3: Shai Shalev-Shwartz, Shaked Shammah, and Amnon Shashua, “On a formal model of safe and scalable self-driving cars,” CoRR, abs/1708.06374, 2017
Non-Patent Document 4: I. Hasuo, C. Eberhart, J. Haydon, J. Dubut, R. Bohrer, T. Kobayashi, S. Pruekprasert, X. Zhang, E. A. Pallas, A. Yamada, K. Suenaga, F. Ishikawa, K. Kamijo, Y. Shinya, and T. Suetomi, “Goal-aware RSS for complex scenarios via program logic,” IEEE Transactions on Intelligent Vehicles, 2023, CoRR abs/2207.02387

### SUMMARY

According to one embodiment of the present disclosure, a control system includes a processor; and a memory storing program instructions that cause the processor to control an operation of an object and output state information indicating a state of the controlled object; perform first control that operates the controlled object according to a first safety rule; perform second control that operates the controlled object according to a second safety rule; and perform the first control in response to determining that the state information satisfies a first switching condition defined based on the first safety rule and the second safety rule, and perform the second control in response to determining that the state information does not satisfy the first switching condition.

### BRIEF DESCRIPTION OF THE DRAWINGS

FIG. 1 is a diagram illustrating an example of a mechanical derivation rule;

FIG. 2 is a block diagram illustrating an example of a hardware configuration of a control system;

FIG. 3 is a block diagram illustrating an example of a functional configuration of a control system in a first embodiment;

FIG. 4 is a flowchart illustrating an example of a control method in the first embodiment;

FIG. 5 is a flowchart illustrating an example of a first switching process in the first embodiment;

FIG. 6 is a flowchart illustrating an example of a second switching process in the first embodiment;

FIG. 7 is a block diagram illustrating an example of a functional configuration of a control system in a second embodiment;

FIG. 8 is a flowchart illustrating an example of a control method in the second embodiment;

FIG. 9 is a flowchart illustrating an example of a first switching process in the second embodiment;

FIG. 10 is a flowchart illustrating an example of a second switching process in the second embodiment; and

FIG. 11 is a flowchart illustrating an example of a third switching process in the second embodiment.

### DETAILED DESCRIPTION

In the related art, there has not been proposed a design method in which safety is logically proven in a simplex architecture incorporating a safety rule.

According to one aspect of the present disclosure, a control system that assures safety can be provided.

Hereinafter, embodiments of the present invention will be described with reference to the accompanying drawings. In this specification and the drawings, components having substantially the same functional configuration are denoted by the same reference numerals, and redundant description thereof will be omitted.

### First Embodiment

A first embodiment of the present invention is a control system configured to control a mobile object (an example of an object) configured to perform autonomous driving. The mobile object in the present embodiment includes, for example, an autonomous vehicle, a route bus with a fixed driving route, an unmanned aircraft, such as a drone, a spacecraft, such as an artificial satellite or an unmanned probe, and the like. The control system in the present embodiment can be applied to, for example, operation control of a plant, in addition to the mobile object. In the following, in the present embodiment, a control system configured to control an autonomous vehicle will be described, for an example.

The control system in the present embodiment is constructed by a simplex architecture incorporating an autonomous driving safety rule. The autonomous driving safety rule in the present embodiment includes, for example, Responsibility-Sensitive Safety (RSS) or Goal-Aware RSS.

### <Autonomous Driving Safety Rule>

Assuring the safety of autonomous driving is an important issue both industrially and socially. In order for autonomous driving to be socially accepted, it is required that the safety assurance and its accountability are clear.

The autonomous driving safety rule is a concept that forms the basis for social acceptance of autonomous driving.

It is conceivable that if society generally recognizes that autonomous vehicles that comply with the autonomous driving safety rule are safe and people can feel secure when autonomous vehicles drive on public roads, the spread of autonomous vehicles will be promoted. Additionally, the autonomous driving safety rule also serves as a standard for specifying the scope of manufacturer responsibility. The idea is that when an accident occurs involving an autonomous vehicle, the manufacturer does not have to take responsibility as long as the vehicle complies with the autonomous driving safety rule.

RSS has been proposed as a method to logically assuring the safety of autonomous driving. RSS is constructed using a logical structure of “If the precondition is satisfied, the safety condition can be satisfied by performing the control strategy.” The control strategy is a measure to control an autonomous vehicle. An example of the control strategy is a driving operation, such as turning a steering wheel, applying a brake, or accelerating by stepping on an accelerator.

RSS disclosed in Non-Patent Document 3 guarantees only the safety condition of collision avoidance. Therefore, Goal-Aware RSS, which extends the RSS and guarantees the goal achievement, has been proposed. The Goal-Aware RSS is constructed by a logical structure of “If the precondition is satisfied, the predetermined postcondition can be achieved while satisfying the safety condition, by performing the control strategy.” According to Goal-Aware RSS, for example, it can be guaranteed that an arbitrary target point can be safely reached.

Hereinafter, RSS disclosed in Non-Patent Document 3 is called Collision Avoiding RSS (CA-RSS) in order to distinguish it from Goal-Aware RSS. Simply referring to RSS includes Collision Avoiding RSS and Goal-Aware RSS.

### <Simplex Architecture>

The simplex architecture has been proposed as a control system to assure safety. The simplex architecture includes an advanced controller (AC), a baseline controller (BC), a decision module (DM) and a plant (P).

The plant operates the object under the control of the advanced controller or the baseline controller. The advanced controller performs complicated control that pursues not only safety but also various performance indexes. The baseline controller performs relatively simple control that emphasizes safety.

The decision module switches between the advanced controller and the baseline controller. The decision module usually switches to the advanced controller for better performance, and switches to the baseline controller when a serious safety problem is detected.

In the simplex architecture, the decision module appropriately switches control between the advanced controller and the baseline controller to assure safety of the entire control system.

<Simplex architecture Incorporating Autonomous Driving Safety Rule>

By incorporating the autonomous driving safety rule into the simplex architecture, an autonomous mobile object can be controlled while switching between the advanced controller and the baseline controller. In this case, the advanced controller is a general autonomous driving control module. The baseline controller is a module that performs a control strategy according to the autonomous driving safety rule.

For example, the decision module monitors an RSS precondition. The decision module causes the advanced controller to control the mobile object while the RSS precondition is satisfied. The advanced controller is a general autonomous driving control module, and thus it performs control considering a performance index, such as comfort.

When the decision module detects that the RSS precondition is unlikely to be satisfied, the decision module switches control from the advanced controller to the baseline controller. The baseline controller performs control according to the control strategy of RSS, and thus it performs control that pursues safety.

With this, the simplex architecture incorporating the autonomous driving safety rule can realize autonomous driving that usually achieves high performance and that can avoid collision when safety is threatened. However, in the simplex architecture incorporating the autonomous driving safety rule, no design method that logically proves safety has been proposed.

It is desired to provide a control system that assures safety in autonomous driving. In one aspect, according to the present embodiment, a simplex architecture incorporating the autonomous driving safety rule can be designed and its safety can be logically proved.

### <Contract to be Satisfied by Safety Rule>

In the present embodiment, a contract to be satisfied by RSS is defined in order to assure safety in autonomous driving. Additionally, a mechanical derivation rule to prove that RSS satisfies the contract is given.

### <<Contract>>

Hoare logic for program verification is known. Goal-Aware RSS defines Hoare quadruples by incorporating a global safety condition and continuous dynamics into Hoare triples given by Hoare logic.

Hoare logic guarantees that “if the precondition P is true, the postcondition Q is true after the program α is executed.” Here, P, α, and Q form a Hoare triple. The Hoare logic is expressed by Expression (1).

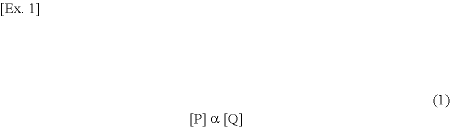

Goal-Aware RSS introduces a program logic system called differential Floyd-Hoare Logic (dFHL), which adds the safety condition S to Hoare triples. The program logic system dFHL guarantees that “if the precondition P is true, the postcondition Q is true after the program α is executed, and the safety condition S is always true during the execution of the program α.” Here, P, α, Q, and S form a Hoare quadruple. The program logic system dFHL is expressed by Expression (2).

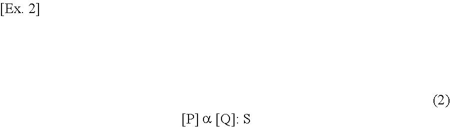

In the present embodiment, a program logic system dFHL_{↓} is introduced in which the safety condition S in the program logic system dFHL is divided into a global assumption A and a global guarantee G. The program logic system dFHL_{↓} guarantees that “under the environmental assumption A, when the precondition P is true, the postcondition Q is true after the program α is executed, and the safety condition G is always true during the execution of the program α.” Here, A, P, α, Q, and G form a Hoare quintuple. The program logic system dFHL_{↓} is expressed by Expression (3).

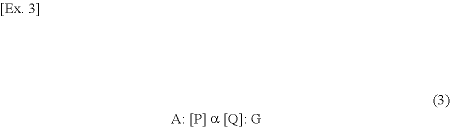

A specific example of Hoare quintuples is described below. The environmental assumption A is, for example, “the maximum acceleration that another vehicle traveling ahead of an ego vehicle can take”. The precondition P is, for example, “positions and speeds of an ego vehicle and another vehicle at time t=t₀.” The control strategy α is, for example, “a driving operation for maintaining a distance between the ego vehicle and another vehicle.” The control strategy α can be formulated based on the positions and speeds of the ego vehicle and another vehicle, the braking performance of the ego vehicle, and the like. The postcondition Q is, for example, “positions and speeds of the ego vehicle and another vehicle at time t=t₁ (>t₀).” The safety condition G is, for example, “the ego vehicle and another vehicle must avoid collision”.

### <<Mechanical Derivation Rules>>

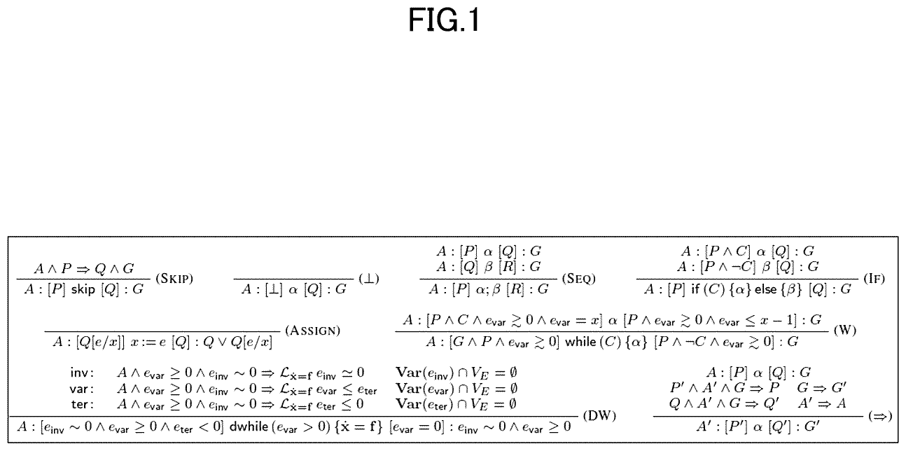

FIG. 1 indicates mechanical derivation rules constituting the program logic system dFHL_{↓}. By using the mechanical derivation rules indicated in FIG. 1, it can be proved that Hoare quintuples (i.e. RSS) satisfy the contract.

### <<Safety Assurance of Simplex Architecture>>

The advanced controller is modeled as the control strategy α, and the baseline controller is modeled as the control strategy β. This indicates that the advanced controller follows the safety rule [P₁, α], and the baseline controller follows the safety rule [P₂, β]. Here, P₁ and P₂ are different preconditions.

The advanced controller may be a general autonomous driving control module, and thus its safety rule is not obvious. If the safety rule of the advanced controller is not defined, it is sufficient to provide the safety rule based on general traffic rules, the performance of autonomous driving vehicles, general common sense, and the like. Additionally, the safety rule may be defined by analyzing the operation of the advanced controller. For the safety rule of the baseline controller, the safety rule defined at the time of design may be used. If the safety rule is unknown, the safety rule may be similarly defined based on assumptions, analysis, or the like.

At this time, for the safety rule [P₁, α], a Hoare quintuple (A₁, P₁, α, Q₁, G₁) that satisfies the contract of Expression (4) can be derived. Additionally, for the safety rule [P₂, β], a Hoare quintuple (A₂, P₂, β, Q₂, G₂) that satisfies the contract of Expression (5) can be derived. However, A₁ and A₂ are different environmental assumptions, Q₁ and Q₂ are different postconditions, and G₁ and G₂ are different safety conditions.

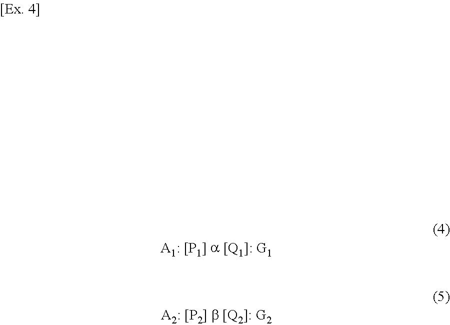

If Expressions (4) and (5) hold, the safety condition G can always be satisfied if the simplex architecture is designed to satisfy Expression (6). In other words, the simplex architecture that satisfies Expression (6) assures safety.

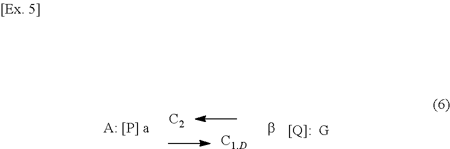

Here, C₁ and D are switching conditions from the control strategy α to the control strategy β. Expression (6) indicates that the control strategy α is performed as long as the switching condition C₁ is true, and when the switching condition C₁ becomes false, the control strategy α is interrupted and switched to the control strategy β. Additionally, Expression (6) also indicates that when the control strategy α is terminated while the switching condition C₁ is true and the switching condition D becomes false, the control strategy β is performed. In other words, Expression (6) indicates that the advanced controller performs control as long as the switching condition C₁ is satisfied, and switches to the baseline controller when the switching condition C₁ or the switching condition D is not satisfied.

Additionally, C₂ is a switching condition from the control strategy β to the control strategy α. Expression (6) indicates that the control strategy β is interrupted and switched back to the control strategy α when the switching condition C₂ becomes false after the switching to the control strategy β is performed. In other words, Expression (6) indicates that the baseline controller is maintained as long as the switching condition C₂ is satisfied, and switches back to the advanced controller when the switching condition C₂ is not satisfied.

### <<Derivation of Switching Conditions>>

The switching conditions of the simplex architecture can be derived based on Hoare quintuples. As the switching conditions, a condition that provides a strong guarantee under a strong assumption (a strong simplex rule) or a condition that provides a weak guarantee under a weak assumption (a weak simplex rule) can be derived.

The switching condition based on the strong simplex rule is derived based on a Hoare quintuple (A, P, α, Q, G) to satisfy the following lemma. In this case, the simplex architecture using the switching conditions C₁, C₂, and D is guaranteed to satisfy the safety condition G.

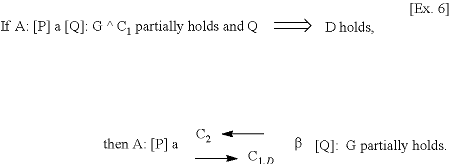

The switching condition based on the weak simplex rule is derived based on Hoare quintuples (A₁, P₁, α, Q₁, G₁) and (A₂, P₂, β, Q₂, G₂) to satisfy the following lemma. In this case, the simplex architecture using the switching the conditions C₁, C₂, and D is guaranteed to satisfy the safety condition G₂.

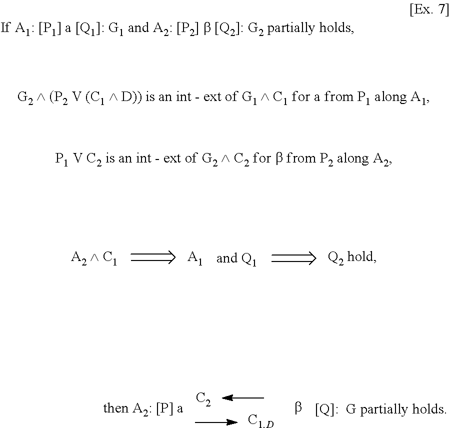

Here, int-ext (interruption-extension) is defined as follows.

$$Assertion E is an interruption - extension of assertion C \qquad [ Ex . 8 ]$$

$$for program α from assertion P along assertion A$$

$$if , for all ρ \text{\vert =} P , σ valid for α from ρ , and ( i , t ) ∈ dom ( σ ) ,$$

$$if for all ( {i}^{′} , {t}^{′} ) ∈ dom ( σ ) such that ( i , t ) < ( i , y ) , σ ( i , t ) \text{\vert =} A ⋀ C ,$$

$$and σ ( i , t ) \text{\vert =} A , then σ ( i , t ) \text{\vert =} E .$$

Based on the switching conditions C₁, C₂, and D derived as described above, if it can be proved that Expression (6) is satisfied, the safety of the control system is logically assured. Additionally, the safety of the control system can be verified by verifying whether the switching conditions C₁, C₂, and D satisfy Expression (6) in the designed control system.

### <Hardware Configuration of Control System>

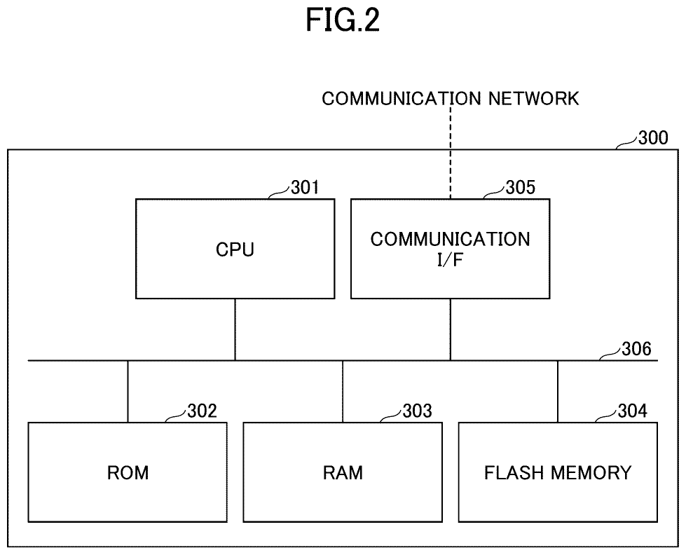

A hardware configuration of the control system 1 in the present embodiment will be described with reference to FIG. 2. The control system 1 in the present embodiment can be implemented by an embedded device, such as an in-vehicle device, for example. FIG. 2 is a block diagram illustrating an example of a hardware configuration of an embedded device 300 in the present embodiment.

As illustrated in FIG. 2, the embedded device 300 includes a central processing unit (CPU) 301, a read only memory (ROM) 302, a random access memory (RAM) 303, a flash memory 304, and a communication interface (I/F) 305. The hardware components of the embedded device 300 are connected to each other via a bus line 306.

The CPU 301 is an arithmetic device configured to read programs and data from a storage device, such as the ROM 302 or the flash memory 304, into the RAM 303 and executes processing, thereby realizing control and functions of the entire embedded device 300.

The ROM 302 is an example of a nonvolatile semiconductor memory (storage device) that can hold programs and data even when the power is turned off. The ROM 302 functions as a storage device for storing various programs, data, and the like that are necessary for the CPU 301 to execute various programs installed in the flash memory 304.

The RAM 303 is an example of a volatile semiconductor memory (storage device) in which programs and data are erased when the power is turned off. The RAM 303 provides a work area where various programs installed in the ROM 302 or the flash memory 304 are deployed when the various programs are executed by the CPU 301.

The flash memory 304 is an example of a nonvolatile semiconductor memory (storage device) for storing programs and data. The flash memory 304 functions as a storage device for storing various programs, data, and the like to be executed by the CPU 301. Additionally, the flash memory 304 provides a temporary storage area for storing data and the like generated when the various programs are executed.

The communication I/F 305 is connected to the communication network 9 and is an interface for the control system 1 to perform data communication.

By having the hardware configuration illustrated in FIG. 2, the embedded device 300 can achieve various processes described later. Here, the hardware configuration illustrated in FIG. 2 is an example, and the embedded device 300 may have other hardware configurations. For example, the embedded device 300 may include a plurality of CPUs 301 or a plurality of RAMs 303.

### <Functional Configuration of Control System>

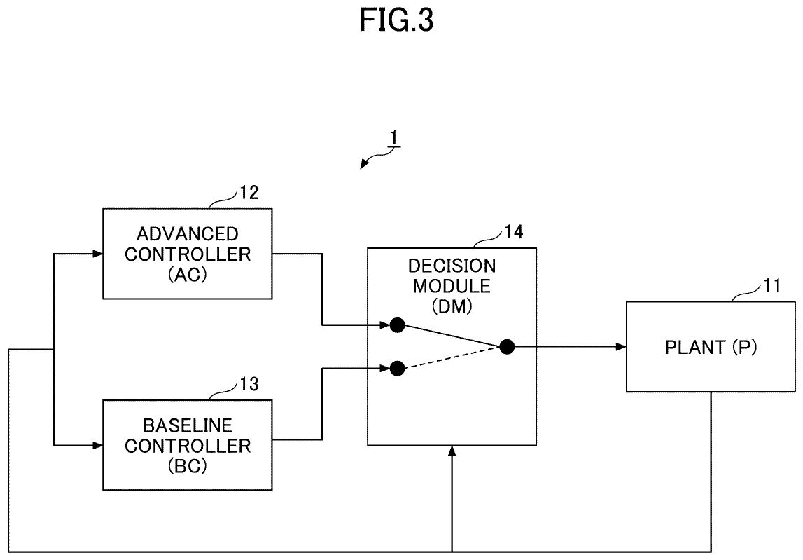

A functional configuration of the control system in the present embodiment will be described with reference to FIG. 3. FIG. 3 is a block diagram illustrating an example of the functional configuration of the control system 1 in the present embodiment.

As illustrated in FIG. 3, the control system 1 in the present embodiment includes a plant 11, an advanced controller 12 (an example of a first controller), a baseline controller 13 (an example of a second controller), and a decision module 14. The control system 1 functions as the plant 11, the advanced controller 12, the baseline controller 13, and the decision module 14 by executing a program installed in advance.

The control system 1 is a control system configured to control an object. In the present embodiment, an autonomous vehicle is controlled as an example of the object. The control system 1 may be, for example, an in-vehicle system mounted on an autonomous vehicle. For example, the control system 1 may be installed on an instrument panel, a center console, or the like of the autonomous vehicle. The control system 1 may be implemented by cloud computing or the like that cooperates with an information processing device installed at a remote location via a cellular phone network or the like.

The plant 11 controls the operation of the autonomous vehicle according to the control strategy performed by the advanced controller 12 or the baseline controller 13. The plant 11 outputs state information indicating the state of the autonomous vehicle while controlling the operation of the autonomous vehicle.

The advanced controller 12 instructs the plant 11 to operate the autonomous vehicle according to a predetermined safety rule. Hereinafter, the safety rule followed by the advanced controller 12 is also referred to as a “first safety rule”. The control that operates the autonomous vehicle according to the first safety rule is referred to as “first control”.

In the present embodiment, the first safety rule is a safety rule implemented by a general autonomous vehicle control module, and is configured to perform complex control for pursuing not only safety but also various performance indexes. The performance indexes are, for example, comfort, the speed, the fuel efficiency, and the like.

The baseline controller 13 instructs the plant 11 to operate the autonomous vehicle according to a predetermined safety rule. Hereinafter, the safety rule followed by the baseline controller 13 is also referred to as a “second safety rule”. The control that operates the autonomous vehicle according to the second safety rule is referred to as “second control”.

In the present embodiment, the second safety rule is configured to perform relatively simple control with emphasis on safety. The second safety rule is an autonomous driving safety rule. The second safety rule preferably includes a stricter safety condition than the first safety rule. The second safety rule may be, for example, Collision Avoidance RSS or Goal-Aware RSS.

The decision module 14 performs switching between the advanced controller 12 and the baseline controller 13. The decision module 14 monitors whether the state information output by the plant 11 satisfies the switching condition C₁ (an example of a first switching condition) and the switching condition D (an example of a third switching condition), or the switching condition C: (an example of a second switching condition) that are predetermined.

The switching condition C₁ is defined based on the first safety rule and the second safety rule. The decision module 14 monitors the switching condition C₁ during the execution of the advanced controller 12. When the state information output by the plant 11 satisfies the switching condition C₁ (when the switching condition C₁ is true), the decision module 14 executes the advanced controller 12. When the state information output by the plant 11 does not satisfy the switching condition C₁ (when the switching condition C₁ is false), the decision module 14 switches to the baseline controller 13.

The switching condition D is defined based on the first safety rule and the second safety rule. The decision module 14 monitors the switching condition D after the execution of the advanced controller 12 is terminated. The decision module 14 switches to the baseline controller 13 when the state information output by the plant 11 does not satisfy the switching condition D (when the switching condition D is false).

The switching condition C₂ is defined based on the first safety rule and the second safety rule. The decision module 14 monitors the switching condition C₂ during the execution of the baseline controller 13. When the state information output from the plant 11 does not satisfy the switching condition C₂ (when the switching condition C₂ is false), the decision module 14 switches to the advanced controller 12. When the state information output from the plant 11 satisfies the switching condition C₂ (when the switching condition C₂ is true), the decision module 14 continues the execution of the baseline controller 13.

### <Control Method by Control System>

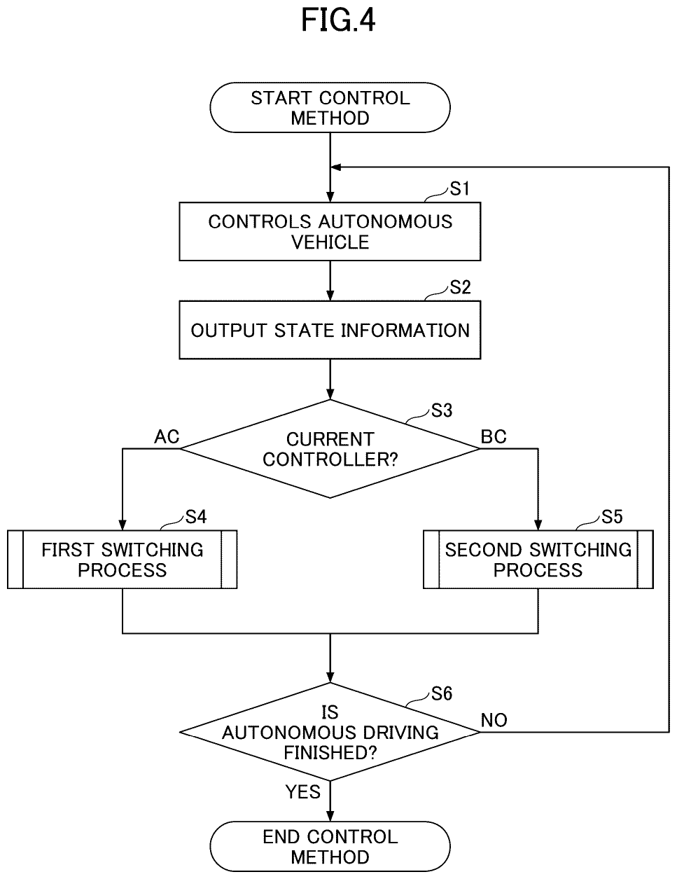

A control method by the control system in the present embodiment will be described with reference to FIG. 4. FIG. 4 is a flowchart illustrating an example of the control method in the present embodiment. The control method is a procedure in which the control system 1 controls the autonomous vehicle.

In step S1, the plant 11 of the control system 1 controls the operation of the autonomous vehicle. In the initial state, the decision module 14 selects the advanced controller 12. Therefore, the plant 11 controls the operation of the autonomous vehicle according to the control strategy α performed by the advanced controller 12.

In step S2, the plant 11 of the control system 1 outputs the state information indicating the state of the autonomous vehicle. The state information output by the plant 11 is transmitted to the advanced controller 12, the baseline controller 13, and the decision module 14.

In step S3, the control system 1 determines the currently selected controller. If the advanced controller 12 is selected (AC), the control system 1 proceeds to step S4. If the baseline controller 13 is selected (BC), the control system 1 proceeds to step S5.

In step S4, the decision module 14 of the control system 1 performs a first switching process. The first switching process is a process for switching from the advanced controller 12 to the baseline controller 13 based on the switching conditions C₁ and D.

### <<First Switching Process>>

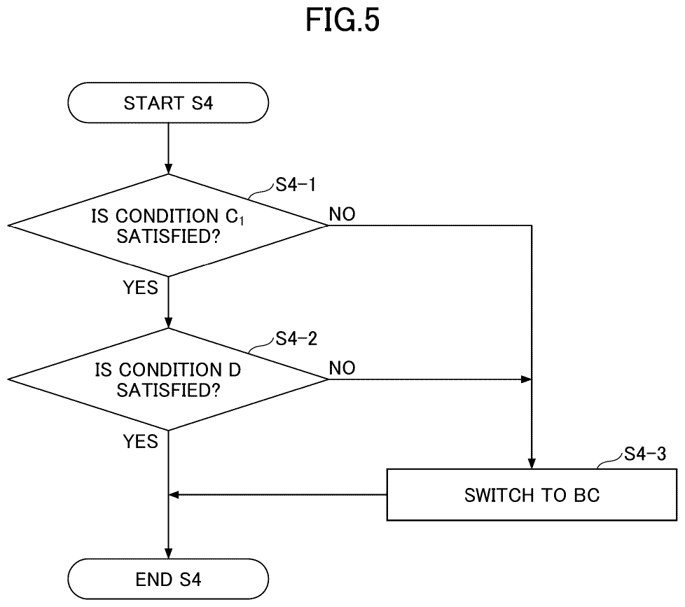

The first switching process in the present embodiment (step S4 in FIG. 4) will be described with reference to FIG. 5. FIG. 5 is a flowchart illustrating an example of the first switching process in the present embodiment.

In step S4-1, the decision module 14 of the control system 1 determines whether the state information output by the plant 11 satisfies the switching condition C₁ (in other words, whether the switching condition C₁ is true or false). If the switching condition C₁ is true (YES), the decision module 14 proceeds to step S4-2. If the switching condition C₁ is false (NO), the decision module 14 proceeds to step S4-3.

In step S4-2, the decision module 14 of the control system 1 determines whether the state information output by the plant 11 satisfies the switching condition D (in other words, whether the switching condition D is true or false). If the switching condition D is false (NO), the decision module 14 proceeds to step S4-3. If the switching condition D is true (YES), the decision module 14 terminates the first switching process without switching to the baseline controller 13.

In step S4-3, the decision module 14 of the control system 1 switches control to the baseline controller 13. Subsequently, the plant 11 controls the operation of the autonomous vehicle according to the control strategy β performed by the baseline controller 13.

Returning to FIG. 4, the description will be provided. In step S5, the decision module 14 of the control system 1 performs a second switching process. The second switching process is a process of switching from the baseline controller 13 to the advanced controller 12 based on the switching condition C₂.

### <<Second Switching Process>>

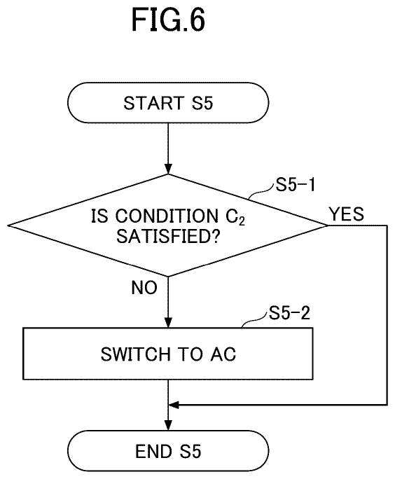

The second switching process in the present embodiment (step S5 in FIG. 4) will be described with reference to FIG. 6. FIG. 6 is a flowchart illustrating an example of the second switching process in the present embodiment.

In step S5-1, the decision module 14 of the control system 1 determines whether the state information output by the plant 11 satisfies the switching condition C₂ (in other words, whether the switching condition C₂ is true or false). If the switching condition Ce is false (NO), the decision module 14 proceeds to step S5-2. If the switching condition C₂ is true (YES), the decision module 14 terminates the second switching process without switching to the advanced controller 12.

In step S5-2, the decision module 14 of the control system 1 switches control to the advanced controller 12. Subsequently, the plant 11 controls the operation of the autonomous vehicle according to the control strategy α performed by the advanced controller 12.

Referring back to FIG. 4, the description will be provided. In step S6, the plant 11 of the control system 1 determines whether to terminate the autonomous driving. If the autonomous driving is terminated (YES), the plant 11 terminates the process of the control method. If the autonomous driving is not terminated (NO), the plant 11 returns the process to step S1.

If the process returns to step S1, the control system 1 controls the operation of the automatic vehicle according to the control strategy performed by the controller selected by the decision module 14. Then, the control system 1 continues the autonomous driving while switching control to the controller corresponding to the state of the automatic vehicle until the autonomous driving is terminated.

### Effect of First Embodiment

The control system 1 in the present embodiment performs control execute the advanced controller 12 when the state information indicating the state of the autonomous vehicle satisfies the switching condition C₁, and execute the baseline controller 13 when the switching condition C₁ is not satisfied. The switching condition C₁ is defined to guarantee that the predetermined safety condition is satisfied. Therefore, according to the present embodiment, the safety of the autonomous driving can be assured.

The control system 1 in the present embodiment performs control to execute the advanced controller 12 when the state information indicating the state of the autonomous vehicle does not satisfy the switching condition C₂. The switching condition C₂ is defined to guarantee that the predetermined safety condition is satisfied. Therefore, according to the present embodiment, control in consideration of the performance index can be performed while assuring the safety of the autonomous driving.

The switching condition C₁ in the present embodiment is defined so that the environmental assumption A, the precondition P, the control strategy α, the postcondition Q, and the safety condition G derived based on the safety rule satisfy the predetermined contract. The predetermined contract guarantees that under the environmental assumption A, when the precondition P is true, the postcondition Q is true during the execution of the control strategy α, and the safety condition G is true during the execution of the control strategy α. Therefore, according to the present embodiment, safety in autonomous driving can be logically assured.

In one aspect, according to the present embodiment, a control system that assures safety in autonomous driving can be designed. Additionally, according to the present embodiment, safety of a control system that controls a mobile object configured to perform autonomous driving can be verified.

### Second Embodiment

In the first embodiment, the configuration in which the control system 1 includes the advanced controller 12 and the single baseline controller 13 has been described. In the second embodiment, a configuration in which the control system 1 includes the advanced controller 12 and a plurality of baseline controllers 13 will be described.

Hereinafter, the control system 1 according to the present embodiment will be described focusing on differences from the first embodiment. Here, the configuration of the control system 1 in the present embodiment will be referred to as a “hierarchical simplex architecture”.

### <<Safety Assurance of Hierarchical Simplex Architecture>>

An advanced controller is modeled as a control strategy α, and two baseline controllers are modeled as control strategies β₁ and β₂. This indicates that the first baseline controller β₁ follows the safety rule [P₁, β₁], and the second baseline controller β₂ follows the safety rule [P₂, β₂]. Here, P₁ and P₂ are different preconditions. In the present embodiment, the advanced controller α does not consider the safety rule.

At this time, for the safety rule [P₁, Bi], a Hoare quintuple (A₁, P₁, β₁, Q₁, G₁) that satisfies the contract of Expression (7) can be derived. For the safety rule [P₂, β₂], a Hoare quintuple (A₂, P₂, β₂, Q₂, G₂) that satisfies the contract of Expression (8) can be derived. Furthermore, the advanced controller α can be modeled by Expression (9). However, A₁ and A₂ are different environmental assumptions, Q₁ and Q₂ are different postconditions, and G, G₁, and G₂ are different safety conditions.

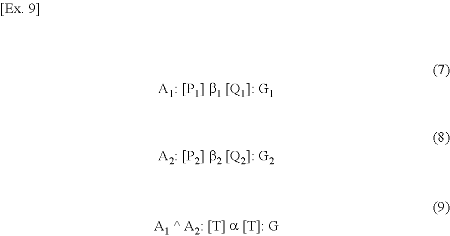

If Expressions (7) to (9) hold, the safety condition G can always be satisfied if the hierarchical simplex architecture is designed to satisfy Expression (10). In other words, the simplex architecture that satisfies Expression (10) assures safety.

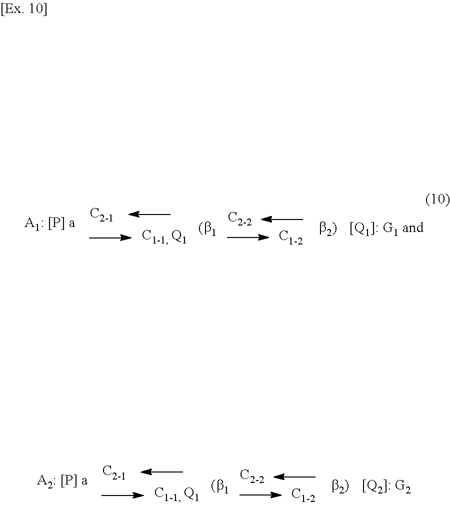

### <<Derivation of Switching Conditions>>

Switching conditions C₁₋₁, C₁₋₂, C₂₋₁, and C₂₋₂ of the hierarchical simplex architecture can be derived based on Hoare quintuples. The switching conditions C₁₋₁, C₁₋₂, C₂₋₁, and C₂₋₂ can be derived based on the Hoare quintuples (A₁, P₁, β₁, Q₁, G₁) and (A₂, P₂, β₂, Q₂, G₂) to satisfy the following theorem. In this case, the hierarchical simplex architecture using the switching conditions C₁₋₁, C₁₋₂, C₂₋₁, and C₂₋₂ is guaranteed to satisfy the safety condition G₂.

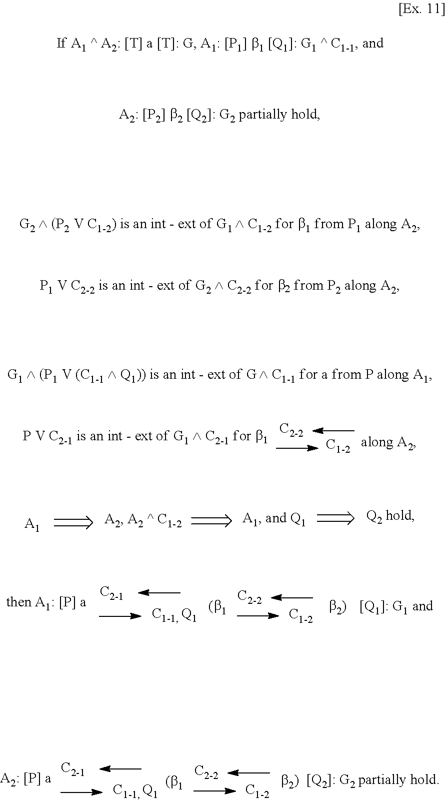

Based on the switching conditions C₁₋₁, C₁₋₂, C₂₋₁, and C₂₋₂ derived as described above, if it can be proved that Expression (10) is satisfied, the safety of the control system is logically assured. Additionally, in the designed control system, the safety of the control system can be verified by verifying whether the switching conditions C₁₋₁, C₁₋₂, C₂₋₁, and C₂₋₂ satisfy Expression (10).

### <Functional Configuration of Control System>

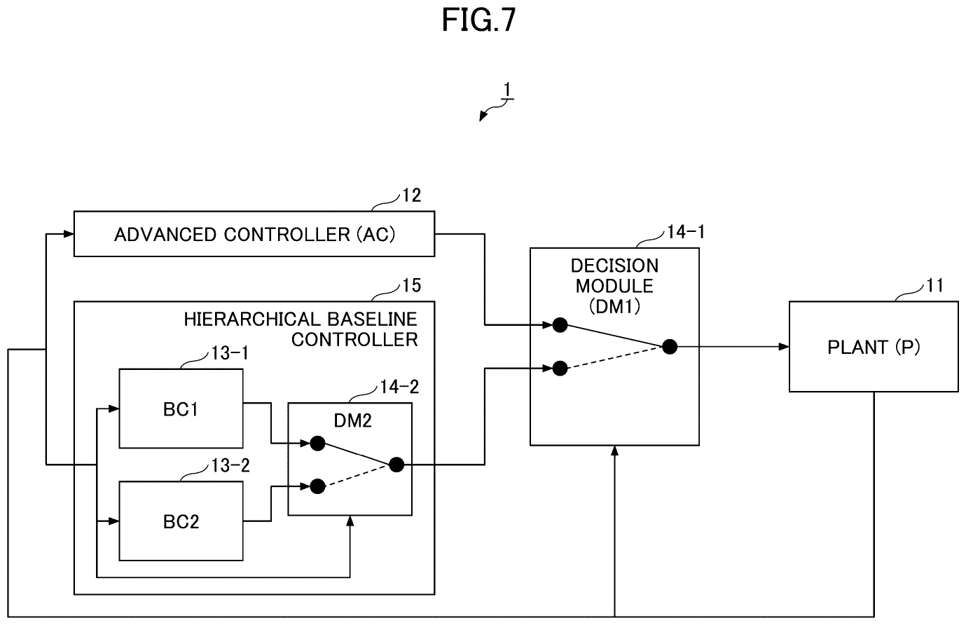

A functional configuration of the control system in the present embodiment will be described with reference to FIG. 7. FIG. 7 is a block diagram illustrating an example of the functional configuration of the control system 1 in the present embodiment.

As illustrated in FIG. 7, the control system 1 in the present embodiment includes the plant 11, the advanced controller 12 (an example of the first controller), a decision module 14-1, and a hierarchical baseline controller 15. The hierarchical baseline controller 15 includes a decision module 14-2 (an example of a second decision module), a baseline controller 13-1 (an example of the second controller), and a baseline controller 13-2 (an example of a third controller).

That is, the control system 1 in the second embodiment differs from the first embodiment in that, instead of the baseline controller 13, the control system 1 includes the decision module 14-2 and the hierarchical baseline controller 15 including two baseline controllers 13-1 and 13-2.

The baseline controller 13-1 instructs the plant 11 to operate the autonomous vehicle according to a predetermined safety rule. Hereinafter, the safety rule followed by the baseline controller 13-1 is also referred to as a “second safety rule”.

The baseline controller 13-2 instructs the plant 11 to operate the autonomous vehicle according to a predetermined safety rule. Hereinafter, the safety rule followed by the baseline controller 13-2 is also referred to as a “third safety rule”.

In the present embodiment, both the second safety rule and the third safety rule are configured to perform relatively simple control with emphasis on safety. Both the second safety rule and the third safety rule are autonomous driving safety rules, but the environmental assumptions A and the safety conditions G are different. The third safety rule preferably defines stricter safety conditions than the second safety rule. For example, the second safety rule may be Goal-Aware RSS, and the third safety rule may be Collision Avoidance RSS.

The decision module 14-1 switches between the advanced controller 12 and the hierarchical baseline controller 15. The decision module 14-1 monitors whether the state information output by the plant 11 satisfies the predetermined switching condition C₁₋₁ (an example of the first switching condition) and D (an example of the third switching condition), or the switching condition C₂₋₁ (an example of the second switching condition).

The function of the decision module 14-1 is substantially the same as that of the decision module 14 in the first embodiment. The switching conditions C₁₋₁ and C₂₋₁ are defined similarly to the switching conditions C₁ and C₂ in the first embodiment.

The decision module 14-2 switches between the baseline controller 13-1 and the baseline controller 13-2. The decision module 14-2 monitors whether the state information output by the plant 11 satisfies the predetermined switching condition C₁₋₂ (an example of a fourth switching condition) or the switching condition C₂₋₂ (an example of a fifth switching condition).

The switching condition C₁₋₂ is defined based on the second safety rule and the third safety rule. The decision module 14-2 monitors the switching condition C₁₋₂ during the execution of the baseline controller 13-1. When the state information output by the plant 11 satisfies the switching condition C₁₋₂ (when the switching condition C₁₋₂ is true), the decision module 14-2 executes the baseline controller 13-1. When the state information output by the plant 11 does not satisfy the switching condition C₁₋₂ (when the switching condition C₁₋₂ is false), the decision module 14-2 switches to the baseline controller 13-2.

The switching condition C₂₋₂ is defined based on the second safety rule and the third safety rule. The decision module 14-2 monitors the switching condition C₂₋₂ during the execution of the baseline controller 13-2. When the state information output by the plant 11 does not satisfy the switching condition C₂₋₂ (when the switching condition C₂₋₂ is false), the decision module 14-2 switches to the baseline controller 13-1. When the state information output by the plant 11 satisfies the switching condition C₂₋₂ (when the switching condition C₂₋₂ is true), the decision module 14-2 continues the execution of the baseline controller 13-2.

### <Control Method by Control System>

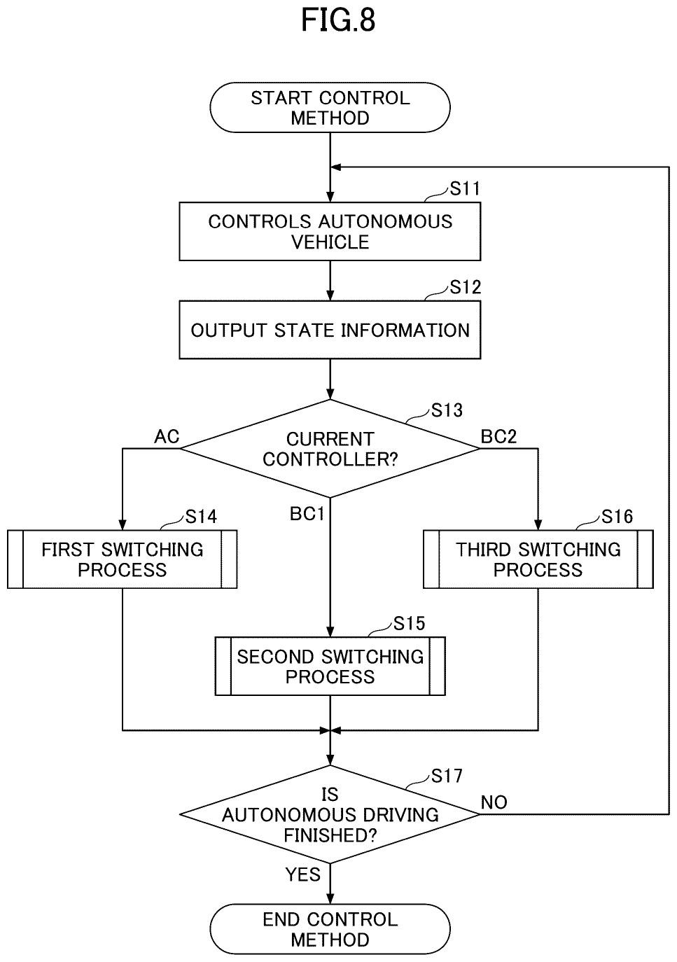

A control method by the control system in the present embodiment will be described with reference to FIG. 8. FIG. 8 is a flowchart illustrating an example of the control method in the present embodiment. The control method is a procedure in which the control system 1 controls the autonomous vehicle. The control method is performed by the control system 1.

In step S11, the plant 11 of the control system 1 controls the operation of the autonomous vehicle. In the initial state, the decision module 14-1 selects the advanced controller 12. Therefore, the plant 11 controls the operation of the autonomous vehicle according to the control strategy α performed by the advanced controller 12.

In step S12, the plant 11 of the control system 1 outputs the state information indicating the state of the autonomous vehicle. The state information output by the plant 11 is transmitted to the advanced controller 12, the hierarchical baseline controller 15, and the decision module 14-1. In the hierarchical baseline controller 15, the input state information is transmitted to the baseline controller 13-1, the baseline controller 13-2, and the decision module 14-2.

In step S13, the control system 1 determines the currently selected controller. If the decision module 14-1 has selected the advanced controller 12 (AC), the control system 1 proceeds to step S14. If the decision module 14-1 has selected the hierarchical baseline controller 15 and the decision module 14-2 has selected the baseline controller 13-1 (BC1), the control system 1 proceeds to step S15. If the decision module 14-1 has selected the hierarchical baseline controller 15 and the decision module 14-2 has selected the baseline controller 13-2 (BC2), the control system 1 proceeds to step S16.

In step S14, the decision module 14-1 of the control system 1 performs a first switching process. The first switching process is a process for switching from the advanced controller 12 to the baseline controller 13-1 based on the switching conditions C₁₋₁ and D.

### <<First Switching Process>>

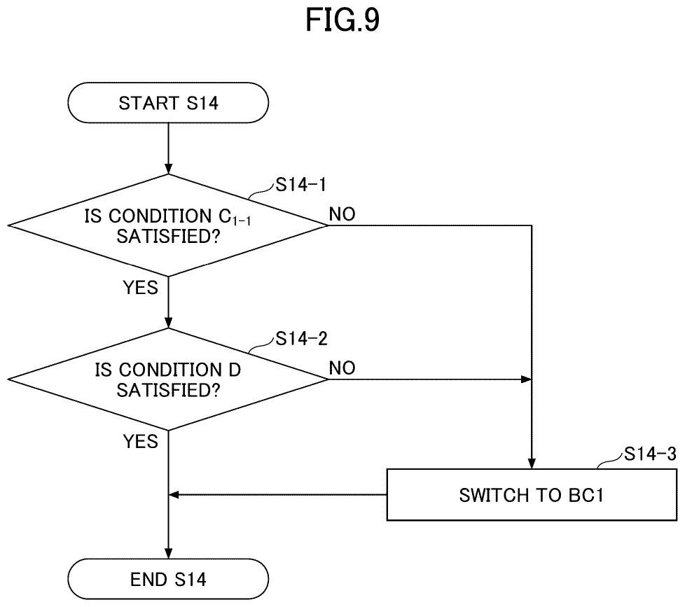

The first switching process (step S14 in FIG. 8) in the present embodiment will be described with reference to FIG. 9. FIG. 9 is a flowchart illustrating an example of the first switching process in the present embodiment.

In step S14-1, the decision module 14-1 of the control system 1 determines whether the state information output by the plant 11 satisfies the switching condition C₁₋₁ (in other words, whether the switching condition C₁₋₁ is true or false). If the switching condition C₁₋₁ is true (YES), the decision module 14-1 proceeds to step S14-2. If the switching condition C₁₋₁ is false (NO), the decision module 14-1 proceeds to step S14-3.

In step S14-2, the decision module 14-1 of the control system 1 determines whether the state information output by the plant 11 satisfies the switching condition D (in other words, whether the switching condition D is true or false). If the switching condition D is false (NO), the decision module 14-1 proceeds to step S14-3. If the switching condition D is true (YES), the decision module 14-1 terminates the first switching process without switching to the baseline controller 13-1.

In step S14-3, the decision module 14-1 of the control system 1 switches control to the hierarchical baseline controller 15. Next, the decision module 14-2 of the hierarchical baseline controller 15 selects the baseline controller 13-1. Subsequently, the plant 11 controls the operation of the autonomous vehicle according to the control strategy β₁ performed by the baseline controller 13-1.

Returning to FIG. 8, the description will be provided. In step S15, the decision module 14-2 of the control system 1 performs a second switching process. The second switching process is a process for switching from the baseline controller 13-1 to the baseline controller 13-2 or the advanced controller 12 based on the switching condition C₂₋₁.

### <<Second Switching Process>>

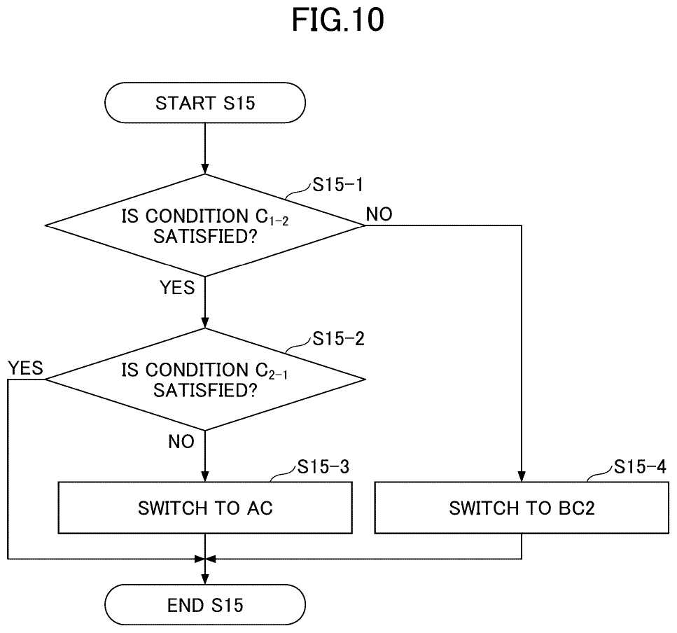

The second switching process (step S15 in FIG. 8) in the present embodiment will be described with reference to FIG. 10. FIG. 10 is a flowchart illustrating an example of the second switching process in the present embodiment.

In step S15-1, the decision module 14-2 of the control system 1 determines whether the state information output by the plant 11 satisfies the switching condition C₁₋₂ (in other words, whether the switching condition C₁₋₂ is true or false). If the switching condition C₁₋₂ is true (YES), the decision module 14-2 proceeds to step S15-2. If the switching condition C₁₋₂ is false (NO), the decision module 14-2 proceeds to step S15-4.

In step S15-2, the decision module 14-1 of the control system 1 determines whether the state information output by the plant 11 satisfies the switching condition C₂₋₁ (in other words, whether the switching condition C₂₋₁ is true or false). If the switching condition C₂₋₁ is false (NO), the decision module 14-1 proceeds to step S15-3. If the switching condition C₂₋₁ is true (YES), the decision module 14-1 terminates the second switching process without switching the controller.

In step S15-3, the decision module 14-1 of the control system 1 switches control to the advanced controller 12. Subsequently, the plant 11 controls the operation of the autonomous vehicle according to the control strategy α performed by the advanced controller 12.

In step S15-4, the decision module 14-2 of the control system 1 switches control to the baseline controller 13-2. Subsequently, the plant 11 controls the operation of the autonomous vehicle according to the control strategy β₂ performed by the baseline controller 13-2.

Returning to FIG. 8, the description will be provided. In step S16, the decision module 14-2 of the control system 1 performs a third switching process. The third switching process is a process for switching from the baseline controller 13-2 to the baseline controller 13-1 based on the switching condition C₂₋₂.

### <<Third Switching Process>>

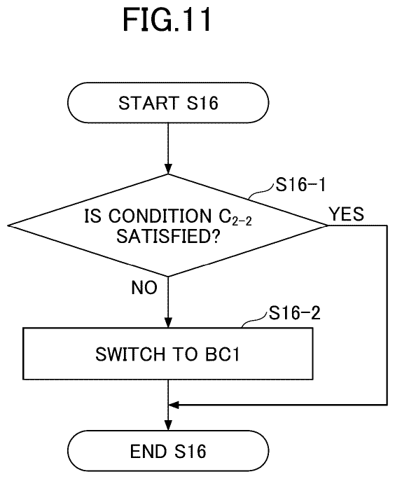

The third switching process (step S16 of FIG. 8) in the present embodiment will be described with reference to FIG. 11. FIG. 11 is a flowchart illustrating an example of the third switching process in the present embodiment.

In step S16-1, the decision module 14-2 of the control system 1 determines whether the state information output by the plant 11 satisfies the switching condition C₂₋₂ (in other words, whether the switching condition C₂₋₂ is true or false). If the switching condition C₂₋₂ is false (NO), the decision module 14-2 proceeds to step S16-2. If the switching condition C₂₋₂ is true (YES), the decision module 14-2 terminates the third switching process without switching to the baseline controller 13-1.

In step S16-2, the decision module 14-2 of the control system 1 switches control to the baseline controller 13-1. Subsequently, the plant 11 controls the operation of the autonomous vehicle according to the control strategy β₁ performed by the baseline controller 13-1.

Returning to FIG. 8, the description will be provided. In step S17, the plant 11 of the control system 1 determines whether to finish the autonomous driving. If the autonomous driving is finished (YES), the plant 11 terminates the process of the control method. If the autonomous driving is not finished (NO), the plant 11 returns the process to step S11.

When the process returns to step S11, the control system 1 controls the operation of the autonomous vehicle according to the control strategy performed by the controller selected by the decision module 14-1 or the decision module 14-2. Then, the control system 1 continues the autonomous driving while switching control to the controller corresponding to the state of the autonomous vehicle until the autonomous driving is finished.

### Effect of Second Embodiment

The control system 1 according to the present embodiment includes the hierarchical baseline controller 15 configured to execute the baseline controller 13-1 when the state information indicating the state of the autonomous vehicle satisfies the switching condition C₁₋₂, and execute the baseline controller 13-2 when the state information indicating the state of the autonomous vehicle does not satisfy the switching condition C₁₋₂. The switching condition C₁₋₂ is defined to guarantee that the predetermined safety condition is satisfied. Therefore, according to the present embodiment, the safety of the autonomous driving can be assured in the control system including three or more controllers.

The control system 1 according to the present embodiment executes the baseline controller 13-1 when the state information indicating the state of the autonomous vehicle does not satisfy the switching condition C₂₋₂. The switching condition C₂₋₂ is defined to guarantee that the predetermined safety condition is satisfied. Therefore, according to the present embodiment, in a control system including three or more controllers, control can be performed in consideration of the performance index while guaranteeing the safety of the autonomous driving.

### [Note]

Each of the functions of the embodiments described above can be achieved by one or more processing circuits. Here, the term “processing circuit” as used herein includes a processor programmed to execute each function by software, such as a processor implemented by an electronic circuit, and a device such as an application specific integrated circuit (ASIC), a digital signal processor (DSP), a field programmable gate array (FPGA), and a conventional circuit module designed to execute each of the functions described above.

Although the embodiments of the present invention have been described in detail above, the present invention is not limited to these embodiments, and various modifications and changes are possible within the scope of the present invention as set forth in the appended claims.

What is claimed is:

1. A control system comprising:
a processor; and
a memory storing program instructions that cause the processor to:
control an operation of an object and output state information indicating a state of the controlled object;
perform first control that operates the controlled object according to a first safety rule;
perform second control that operates the controlled object according to a second safety rule; and
perform the first control in response to determining that the state information satisfies a first switching condition defined based on the first safety rule and the second safety rule, and perform the second control in response to determining that the state information does not satisfy the first switching condition.

2. The control system as claimed in claim 1, wherein the program instructions cause the processor to perform the first control in response to determining that the state information does not satisfy a second switching condition defined based on the second safety rule during the performing of the second control.

3. The control system as claimed in claim 2, wherein the program instructions cause the processor to perform the second control in response to determining that the state information does not satisfy a third switching condition defined based on a safety condition of the first safety rule during the performing of the first control.

4. The control system as claimed in claim 1, wherein the program instructions cause the processor to:
perform third control that operates the controlled object according to a third safety rule; and
perform the second control in response to determining that the state information does not satisfy the first switching condition and satisfies a fourth switching condition defined based on the second safety rule and the third safety rule, and perform the third control in response to determining that the state information does not satisfy the first switching condition and does not satisfy the fourth switching condition.

5. The control system as claimed in claim 4, wherein the program instructions cause the processor to perform the second control in response to determining that the state information does not satisfy a fifth switching condition defined based on the third safety rule during the performing of the third control.

6. The control system as claimed in claim 1, wherein the second safety rule defines that a control strategy for controlling the controlled object is performed in response to determining that a predetermined precondition is true, and the first switching condition is defined such that an environmental assumption, a postcondition, and a safety condition that are derived based on the precondition and the control strategy satisfy a predetermined contract.

7. The control system as claimed in claim 6, wherein the contract guarantees that, under the environmental assumption, when the precondition is true, the postcondition is true during the performing of the control strategy, and the safety condition is true during the performing of the control strategy.

8. A control method comprising:
controlling an operation of an object and outputting state information indicating a state of the controlled object;
performing first control that operates the controlled object according to a first safety rule;
performing second control that operates the controlled object according to a second safety rule; and
performing the first control in response to determining that the state information satisfies a first switching condition defined based on the first safety rule and the second safety rule, and performing the second control in response to determining that the state information does not satisfy the first switching condition.

9. A non-transitory computer-readable recording medium having stored therein a program for causing a processor to perform:
controlling an operation of an object and outputting state information indicating a state of the controlled object;
performing first control that operates the controlled object according to a first safety rule;
performing second control that operates the controlled object according to a second safety rule; and
performing the first control in response to determining that the state information satisfies a first switching condition defined based on the first safety rule and the second safety rule, and performing the second control in response to determining that the state information does not satisfy the first switching condition.

10. The control system as claimed in claim 1, wherein the object is an autonomous vehicle.

11. The control system as claimed in claim 1,
wherein the object is an autonomous vehicle, and
wherein the operation of the object is a driving operation including turning a steering wheel, applying a brake, or accelerating.
